(19) United States
(12) Patent Application Publication
(10) Pub. No.: US 2011/0102381 A1
(43) Pub. Date: May 5, 2011

(54) APPARATUS AND METHOD FOR PORTABLE TERMINAL HAVING OBJECT DISPLAY DIAL

(75) Inventors: Dong-Young CHOI, Suwon-si (KR); Jae-Gon SON, Suwon-si (KR); Hong-Seok KWON, Suwon-si (KR); Kang-Wook KIM, Hwaseong-si (KR); Tae-Jung KIM, Suwon-si (KR)

(73) Assignee: SAMSUNG ELECTRONICS CO. LTD., Suwon-si (KR)

(21) Appl. No.: 12/908,442

(22) Filed: Oct. 20, 2010

(30) Foreign Application Priority Data
Nov. 4, 2009 (KR) 10-2009-0106219

(51) Int. Cl. G09G 5/00

(52) U.S. Cl. 345/184

(57) ABSTRACT

An apparatus and method for executing a specific function by rotating an object display dial capable of displaying at least one of a mode-based object and a function-based object are provided. The portable terminal includes a mode/function determination unit for determining a mode or function of the portable terminal, a User Interface (UI) object generation unit for generating an object corresponding to each mode or function on the object display dial, a UI object display unit for displaying the generated, a dial rotation detection unit for detecting a rotation of the object display dial, a position determining unit for determining a position of an object upon detecting the rotation of the object display dial, and an object display dial capable of displaying at least one of the mode-based object and the function-based object and including a mode/function execution unit for transitioning to a mode corresponding to an object assigned to the position or for executing the function.

### PRIORITY

This application claims the benefit under 35 U.S.C. §119(a) of a Korean patent application filed on Nov. 4, 2009 in the Korean Intellectual Property Office and assigned Serial No. 10-2009-0106219, the entire disclosure of which is hereby incorporated by reference.

### BACKGROUND OF THE INVENTION

1. Field of the Invention

The present invention relates to an apparatus and method for mode selection in a portable terminal. More particularly, the present invention relates to an apparatus and method for executing a specific function or for determining a mode by rotating an object display dial capable of displaying at least one of a mode-based object and a function-based object in a portable terminal having the dial, and for defining the at least one of the mode-based object and the function-based object according to a position of the dial.

2. Description of the Related Art

Recently, with the rapid development of portable terminals, a mobile terminal providing wireless voice calls and data exchanges is regarded as personal necessity of life. A conventional portable terminal has generally been regarded as a portable device providing wireless calls. However, along with technical advances and introduction of the wireless Internet, the portable terminal is now used for many purposes in addition to telephone calls or scheduling. For example, the portable terminal provides a variety of functions to satisfy users' demands, such as, games, remote controlling using near field communication, capturing images using a built-in digital camera, and the like.

In order to use the aforementioned functions, a user of the portable terminal inputs keys for selecting the functions.

Recently, the portable terminal employs a dial to change a mode so that the user can simply select the mode. The dial is implemented in a camera or the like in a HardWare (H/W) manner to execute an operation mode selected by rotating a mode dial having a shape of a rotary plate, and to provide a display screen in association with the selected operation mode among various display information including an icon.

However, since the dial is implemented in the H/W manner, when the dial rotates, the functions are executed by delivering a signal in the H/W manner, for example, by pressing a button corresponding to each position. Therefore, there is a problem in that only a limited operation for a camera-related mode is defined in a mode dial when a product is initially launched and a general-purpose function cannot be executed.

In addition, when using a device having a small number of key input buttons such as a full touch terminal, only a function defined in the mode dial can be determined, and thus it is difficult to manipulate various functions of the portable terminal.

Therefore, a need exists for a system and method for a portable terminal having an object display dial that is capable of displaying at least one of a mode-based object and a function-based object.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for a portable terminal having an object display dial capable of displaying at least one of a mode-based object and a function-based object.

Another aspect of the present invention is to provide an apparatus and method in which, after rotating an object display dial of a portable terminal, a function corresponding to an object assigned to a position of the rotated dial is determined or executed.

Another aspect of the present invention is to provide an apparatus and method for providing a diversity of a user input method by editing an object to be allocated to an object display dial in a portable terminal.

In accordance with an aspect of the present invention, a portable terminal having an object display dial capable of displaying at least one of a mode-based object and a function-based object is provided. The portable terminal includes a mode/function determination unit for determining a mode or a function of the portable terminal, a User Interface (UI) object generation unit for generating an object for displaying an object corresponding to each mode or each function on the object display dial according to the determined mode or the determined function, a UI object display unit for displaying the generated object on a display unit of the object display dial, a dial rotation detection unit for detecting a rotation of the object display dial, a position determining unit for determining a position of an object corresponding to a position of the rotated dial upon detecting of the rotation of the object display dial, and an object display dial capable of displaying at least one of the mode-based object and the function-based object and including a mode/function execution unit for transitioning to a mode corresponding to an object assigned to the position or for executing the function.

In accordance with another aspect of the present invention, a method of operating a portable terminal having an object display dial capable of displaying at least a mode-based object and a function-based object is provided. The method includes determining a mode or a function by receiving a specific signal, determining the mode or the function determined when the signal is received, displaying an object corresponding to the determined mode or the determined function to a display unit of the object display dial, detecting a rotation of the object display dial, determining a position of the rotated object display dial, and executing and displaying a mode or a function of an object displayed in a position corresponding to the determined position.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description taken in conjunction with the accompanying drawings, in which:

FIG. 1 illustrates a portable terminal having an object display dial capable of displaying at least one of a mode-based object and a function-based object according to an exemplary embodiment of the present invention;

FIG. 2A illustrates a mode object displayed on a display unit of an object display dial according to an exemplary embodiment of the present invention;

FIG. 2B illustrates a function object displayed on a display unit of an object display dial according to an exemplary embodiment of the present invention;

FIG. 2C illustrates function objects related to an output camera, when an object display dial is selected as a camera mode object, according to an exemplary embodiment of the present invention;

FIG. 3 is a block diagram illustrating an internal structure of a portable terminal having an object display dial capable of displaying at least one of a mode-based object and a function-based object according to an exemplary embodiment of the present invention;

FIG. 4 is a flowchart illustrating a process of executing a specific function by manipulating an object display dial capable of outputting an object in a portable terminal according to an exemplary embodiment of the present invention; and

FIG. 5 is a flowchart illustrating a process of determining a dial display object capable of outputting an object in a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention described below relate to an apparatus and method for determining or executing a function corresponding to an object assigned to a rotation position of an object display dial capable of displaying at least one of a mode-based object and a function-based object in a portable terminal. In the following description, the object is an icon for a specific application program, and is variably output on the dial according to a mode or a function.

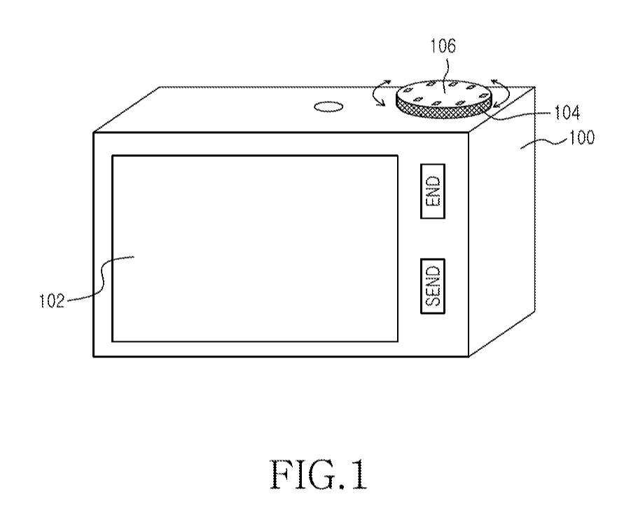

FIGS. 1 through 5, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 illustrates a portable terminal having an object display dial capable of displaying at least one of a mode-based object and a function-based object according to an exemplary embodiment of the present invention.

Referring to FIG. 1, a portable terminal 100 includes an object display dial 104 having a display unit 106, a display panel 102, and a control unit (not illustrated). The portable terminal may include additional units that are not illustrated here merely for the sake of clarity. Similarly, the functionality of two or more of the above units may be integrated into a single component without departing from the spirit or scope of the present invention.

The object display dial 104 having the display unit 106 can rotate in a specific direction. Objects for representing a mode or function of the portable terminal 100 are output to the display unit 106. The dial 104 may have a stopper (not shown) in a saw-tooth or notch shape so that the dial 104 can rotate in association with a specific angle. In addition, the display unit 106 of the dial 104 may include a Liquid Crystal Display (LCD) panel, an Active-Matrix Organic Light-Emitting Diode (AMOLED), an E-ink panel, and the like. The display unit 106 is coupled to the dial 104, so that the display unit 106 rotates along with the rotation of the dial 104. Accordingly, when the dial 104 rotates in a specific angle, the portable terminal 100 determines a position of the rotated dial 104, and determines or executes a mode corresponding to an object assigned to the position.

The display panel 102 outputs the mode determined by the rotation of the dial 104 or a function executed by the rotation of the dial 104. The display panel 102 can be implemented with a conventional LCD and can be implemented with a display panel having a touch panel used to enable a touch input. Therefore, when inputting a signal for executing the mode or the function, the portable terminal may generate a signal for executing the mode or the function by using the display panel 102 or may generate the signal by using a specific external key.

The control unit (not illustrated) executes a command for determining the mode by receiving a signal input through the display panel 102 or the specific external key, and executes a command for executing a specific function or mode corresponding to an object displayed according to the rotation of the dial 104.

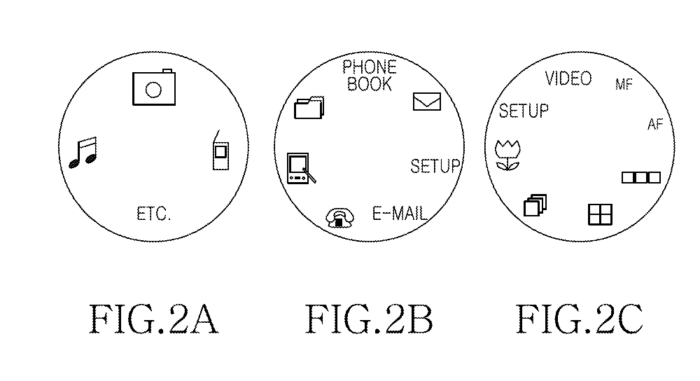

FIGS. 2A through 2C are views illustrating an object display dial capable of displaying an object according to an exemplary embodiment of the present invention.

FIG. 2A illustrates a mode object displayed on a display unit of an object display dial according to an exemplary embodiment of the present invention.

Referring to FIG. 2A, the portable terminal can output mode objects, which are predetermined or allocated by a user, to the display unit of the object display dial.

For example, the portable terminal can output the mode objects for representing a phone function, a camera function, a multimedia function, an extra function, and the like, to the display unit of the dial, and thereafter can execute the phone function, the multimedia function, the extra function, and the like, by the user selection.

FIG. 2B illustrates a function object displayed on a display unit of an object display dial according to an exemplary embodiment of the present invention.

Referring to FIG. 2B, the portable terminal can output the mode object of FIG. 2A, enter a mode selected when a user rotates the dial, and change objects of the display unit to corresponding function objects.

For example, among mode objects for representing a phone function, a camera function, a multimedia function, an extra function, and the like, if the user selects an object for the phone function through the display unit of the dial, the portable terminal changes the mode objects for representing the phone function, the camera function, the multimedia function, the extra function, and the like, to objects of a conventional phone function such as a phone book, a message, a phone function environment setup, a storage folder, and the like.

FIG. 2C illustrates function objects related to an output camera, when an object display dial is selected as a camera mode object, according to an exemplary embodiment of the present invention.

Referring to FIG. 2C, a user of the portable terminal outputs the mode object of FIG. 2A, and then selects a camera mode by rotating the dial. The portable terminal outputs a function object corresponding to a video function depending on the camera mode, a manual function, an auto function, a split capture function, a close-up function, and the like. In this case, the portable terminal also outputs an object corresponding to another mode in addition to the function object corresponding to the camera mode, so as to enable prompt movement to another object.

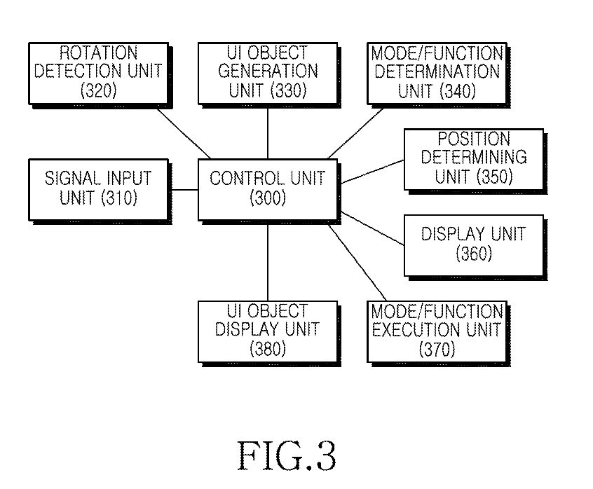

FIG. 3 is a block diagram illustrating an internal structure of a portable terminal having an object display dial capable of displaying at least one of a mode-based object and a function-based object according to an exemplary embodiment of the present invention.

Referring to FIG. 3, the portable terminal includes a control unit 300, a signal input unit 310, a rotation detection unit 320, a User Interface (UI) object generation unit 330, a mode/function determination unit 340, a position determining unit 350, a display unit 360, a mode/function execution unit 370, and a UI object display unit 380.

The signal input unit 310 of the portable terminal receives a signal input from a touch display panel or a specific key according to selection of a user. That is, when the user determines a mode or selects an object by using a display panel having a specific key (not illustrated) or a touch panel included in the portable terminal, a signal generated by rotation of the dial is received.

The rotation detection unit 320 is an element for detecting rotation of the object display dial. The rotation detection unit 320 determines whether the rotation of the dial is detected, and upon detecting the rotation of the dial, reports the detection of the rotation to the control unit 300.

The UI object generation unit 330 generates UI objects for representing the mode or the function according to a signal input of the signal input unit 310. For example, when the UI objects represent the mode, an object corresponding to a phone mode, a camera mode, a multimedia mode, and the like, is generated. When the UI objects represent the function, specific functions corresponding to the respective modes are generated.

The mode/function determination unit 340 determines the phone mode, the camera mode, the multimedia mode, and the like, upon receiving a signal for determining a mode from the dial.

The position determining unit 350 detects the rotation of the dial to determine whether an object displayed on the dial corresponds to a position at which the mode or the function is to be executed, and delivers a corresponding signal to the control unit 300.

The display unit 360 displays a screen for executing the mode and the function and a screen for showing a result obtained by executing the mode and the function. For example, when a specific signal is input from a display panel having a specific key or a touch panel, the display unit 360 activates and displays a mode or function corresponding to the signal. In addition, when a signal for executing the mode or the function is input through the rotation of the dial, the display unit 360 activates and displays the mode or the function.

The mode/function execution unit 370 detects the rotation of the dial, and moves an object displayed on the dial to a position at which the object is to be executed. The position determining unit 350 determines whether the position is a preset position. Thereafter, the mode/function execution unit 370 receives a signal for executing a mode or function corresponding to the object and executes the mode or function corresponding to the object.

The UI object display unit 380 can display the object displayed on the dial in a virtual dial format on a display according to the rotation of the dial.

The control unit 300 receives a specific signal and executes a mode or function corresponding to the signal. Further, the control unit 300 delivers and executes a command for displaying the result on the display unit.

The term “unit” used herein means, but is not limited to, a software or hardware component, such as a Field Programmable Gate Array (FPGA) or Application Specific Integrated Circuit (ASIC), which performs certain tasks. The unit may be configured to reside on the addressable storage medium and configured to execute on one or more processors. Thus, the unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided in the components and units may be combined into fewer components or further separated into additional components and units. In addition thereto, the components and units can be implemented to reproduce one or more Central Processing Units (CPUs) included in a device or a security multimedia card.

An apparatus for a portable terminal having an object display dial capable of displaying at least one of a mode-based object and a function-based object has been described above according to an exemplary embodiment of the present invention. Hereinafter, a method of determining or executing a function corresponding to an object assigned to a rotation position of the dial by using the apparatus will be described according to an exemplary embodiment of the present invention.

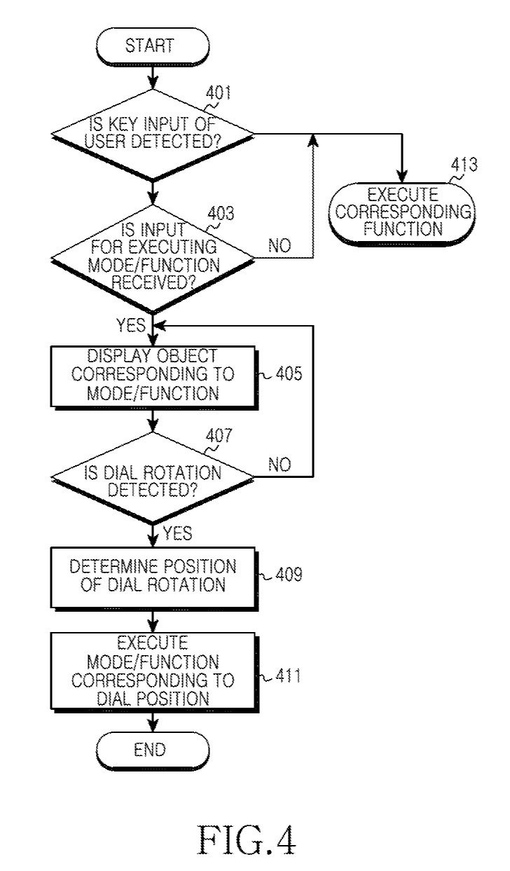

FIG. 4 is a flowchart illustrating a process of executing a specific function by manipulating an object display dial capable of outputting an object in a portable terminal according to an exemplary embodiment of the present invention.

Referring to FIG. 4, the dial includes a display window for outputting one or more objects. The objects displayed on the display window rotate according to the rotation of the dial. Therefore, when the dial rotates, the portable terminal determines an object corresponding to the rotation position and performs an operation for the object.

The portable terminal determines whether a key input of a user is detected in step 401. The key input may be an input of a specific key provided externally in a hardware manner or an input of a key output on a display unit in a software manner.

If it is determined in step 401 that the key input of the user is not detected, the portable terminal executes a predetermined mode (e.g., a standby mode) in step 413.

In contrast, if it is determined in step 401 that the key input of the user is detected, the portable terminal determines whether an input for executing a mode/function is detected in step 403.

The input for executing the mode/function implies that the user of the portable terminal intends to execute the mode or the function by rotating the dial. The user can execute a phone mode, a camera mode, an extra mode, and the like, by rotating the dial. In this case, when the user selects any one mode, the portable terminal outputs a plurality of functions included in the mode on the display unit of the dial.

If it is determined in step 403 that the input for executing the mode/function is not detected, the portable terminal re-performs the process of step 401.

In contrast, if it is determined in step 403 that the input for executing the mode/function is detected, the portable terminal outputs an object corresponding to a function based on a mode defined in the dial or a type of the defined mode to the display unit of the dial in step 405.

For example, when the user performs a mode setup process for the dial rotation, the portable terminal outputs an object corresponding to a camera mode, a phone mode, a game mode, and a music playback mode in step 405. Among these modes, if the user executes the phone mode, an object corresponding to the phone book mode (e.g., a phone book function, a message function, a recent outgoing number function, and the like) is output.

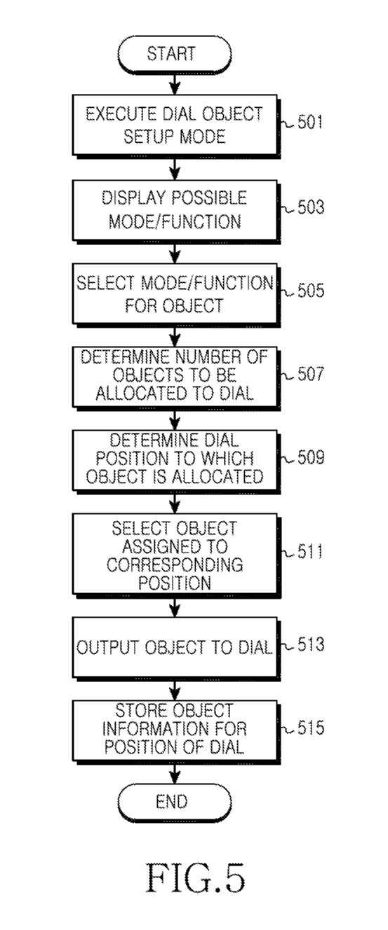

In this case, the portable terminal divides a circular-shaped dial in a specific direction, and outputs the object in the divided direction. In addition, the user can divide a direction of the dial capable of outputting the object by a desired rotation distance. A process of outputting the object to the dial will be described below in detail with reference to FIG. 5.

After that, the portable terminal determines whether the dial rotation of the user is detected in step 407.

If it is determined in step 407 that the dial rotation of the user is not detected, the portable terminal re-performs the process of step 405.

In contrast, if it is determined in step 407 that the dial rotation of the user is detected, the portable terminal determines a dial's rotation position to which the dial can freely rotate to the left or right in step 409.

The portable terminal determines whether the position to which the dial rotates is a position at which a specific object output to the display unit of the dial executes a mode or a function, and executes an object corresponding to the position in step 411.

That is, if the rotation position of the dial is the position for executing the mode, the portable terminal transitions to a mode corresponding to the object, and if the rotation position of the dial is a position for executing the function, a function corresponding to the object is executed.

When executing the object for the mode or the function as described above, the portable terminal outputs a screen for executing the object on the display unit.

For example, if the rotation position of the dial is an object related to a phone book, objects previously output are replaced with a frequently used phone number. Accordingly, the user selects the number by the rotation of the dial and outputs the number to the display unit, and then can execute a call connection to the number.

The user of the portable terminal can simply change a digital broadcast channel, and can input a frequently used text to the dial in order to improve a speed of writing a message.

Thereafter, the procedure of FIG. 4 ends.

FIG. 5 is a flowchart illustrating a process of determining a dial display object capable of outputting an object in a portable terminal according to an exemplary embodiment of the present invention.

Referring to FIG. 5, the portable terminal executes a dial object setup mode in step 501. The dial object setup mode is a mode for adding an object desired by a user to the dial, and is executed at the request of the user.

The portable terminal outputs objects corresponding to a possible mode and function in step 503 and the portable terminal selects whether an object to be determined is an object for the mode or an object for the function in step 505.

After that, the portable terminal determines the number of objects to be allocated to the dial in step 507. The number of objects to be allocated to the dial relates to dividing of a direction of the dial. For example, when the user of the portable terminal allocates three objects to the dial in a portable phone mode, a camera mode, and an extra mode, the dial can be allocated with the three objects respectively in three directions divided with an interval of 120°. That is, the user of the portable terminal can allocate a desired number of objects by adjusting a rotation distance between the objects.

The portable terminal determines a position of the dial to which the object is allocated in step 509.

The position of the dial relates to determining of the position of the dial to which an object selected by the user is allocated among the objects output in step 503. Among a plurality of directions divided by the user, a current position to which the dial rotates is a position to which the object is allocated.

In step 511, the portable terminal selects an object to be allocated to the dial position determined in step 509. The portable terminal outputs the selected object to a display unit of the dial or outputs a virtual dial, which is generated on a screen by using an object corresponding to the object, to the display unit in step 513. The virtual dial output to the display unit is output in association with an actual dial to which the object is allocated.

The portable terminal stores information of the object corresponding to the dial position in step 515, and then the procedure of FIG. 5 ends.

Although a method of determining at least one of a mode-based object and a function-based object by differentiating them is described in FIG. 5, the dial in exemplary embodiments of the present invention can determine the mode-based object or the function-based object by combining them, so that a mode can immediately transition to another mode in a function object screen.

According to exemplary embodiments of the present invention, a portable terminal includes a rotating dial capable of displaying a mode or a function so that respective objects can be conveniently manipulated by executing a mode or function corresponding to a rotation position to which the dial rotates. In addition, the dial included in the portable terminal can be used to determine an object by a user and can determine an object for various modes or functions.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A portable terminal having an object display dial capable of displaying at least one of a mode-based object and a function-based object, the portable terminal comprising:
a mode/function determination unit for determining a mode or a function of the portable terminal;
a User Interface (UI) object generation unit for generating an object for displaying an object corresponding to each mode or function on the object display dial according to the determined mode or function;
a UI object display unit for displaying the generated object on a display unit of the object display dial;
a dial rotation detection unit for detecting a rotation of the object display dial;
a position determining unit for determining a position of an object corresponding to a position of the rotated dial upon detecting the rotation of the object display dial; and an object display dial capable of displaying at least one of the mode-based object and the function-based object and including a mode/function execution unit for transitioning to a mode corresponding to an object assigned to the position or for executing the function.

2. The portable terminal of claim 1, wherein the object is an image and includes the object display dial capable of displaying at least one of the mode-based object and the function-based object variably displayed on a display window in association with the mode or the function.

3. The portable terminal of claim 1, wherein the object is an icon for a specific application program, and is variably output on the dial according to the mode or the function.

4. The portable terminal of claim 1, further comprising:
a signal input unit for receiving a signal input of a user to determine the mode or the function
wherein the display unit displays a mode corresponding to the position of the rotated object display dial or a function execution screen.

5. The portable terminal of claim 1, wherein the object display dial includes a display window for displaying at least one of the mode and the function of the object generated by the UI object generation unit on the dial.

6. The portable terminal of claim 1, wherein the mode includes at least one of a phone mode, a camera mode, and an extra mode.

7. The portable terminal of claim 1, wherein the object represents the mode or the function.

8. The portable terminal of claim 3, wherein, when the object is displayed, the display unit displays a virtual dial having a shape of the dial and displays the object on the virtual dial.

9. A method of operating a portable terminal having an object display dial capable of displaying at least one of a mode-based object and a function-based object, the method comprising:
determining a mode or a function upon receiving a specific signal;
displaying an object corresponding to the determined mode or function on a display unit of the object display dial;
detecting a rotation of the object display dial;
determining a position of the rotated object display dial; and
executing and displaying the mode or the function of an object displayed in a position corresponding to the determined position.

10. The method of claim 9, wherein the mode includes at least one of a phone mode, a camera mode, and an extra mode.

11. The method of claim 9, further comprising:
receiving a specific signal;
determining an object of the dial, so that the object is changeable, when the signal is received;
displaying the changeable object; and
upon selecting the object, displaying the object on a display window of the dial.

12. The method of claim 9, wherein the object represents the mode or the function.

13. The method of claim 9, wherein the object is an image and includes the object display dial capable of displaying at least one of the mode-based object and the function-based object variably displayed on a display window in association with the mode or the function.

14. The method of claim 9, wherein the object is an icon for a specific application program, and is variably output on the dial according to the mode or the function.

15. The method of claim 9, wherein the object display dial includes a display window for displaying at least one of the mode and the function of the object generated by a User Interface (UI) object generation unit on the dial.

16. The method of claim 9, wherein, when the object is displayed, a virtual dial having a shape of the dial is displayed, and the object is displayed on the virtual dial.
